(19) United States
(12) Patent Application Publication
(10) Pub. No.: US 2013/0308315 A1
(43) Pub. Date: Nov. 21, 2013

(54) LIGHT-BULB AND AUDIO/LIGHTING SYSTEM

(71) Applicants: Vittorio Capitani, Parma (IT); Cristina Pavarani, Parma (IT)

(72) Inventors: Vittorio Capitani, Parma (IT); Cristina Pavarani, Parma (IT)

(73) Assignee: KOS S.R.L., Montechiarugolo (IT)

(21) Appl. No.: 13/879,497

(22) PCT Filed: Oct. 14, 2010
(86) PCT No.: PCT/IT2010/000418

§ 371 Date: Jul. 1, 2013

(51) Int. Cl. F21V 33/00

(52) U.S. Cl. CPC F21V 33/0056
USPC 362/253

(57) ABSTRACT

A light-bulb (1) comprises: a connector (6) designed to connect the light-bulb (1) to a lamp holder or to a socket for electrically powering the said light-bulb (1); a body (5) with an elongated form along an axis (A) and a side wall (41) defining an inner space (90), said body (5) having a first end connected to the connector (6) and a second open end for defining an outer portion (43) opposite to the engaging connector (6); at least one lighting element (200) arranged inside the space (90); a receiver (15) arranged inside the space (90) and able to communicate wirelessly with a sound signal emitter (32); an amplifier (56) arranged inside the space (90) and connected to the receiver (15) and to the loudspeaker (16) in order to amplify the signal received from the receiver; an acoustic loudspeaker (16) arranged inside the space (90) and connected to the amplifier (56) so as to receive said signal and emit corresponding sound waves; an annular support (46) arranged inside the space (90) in said outer portion (43) and defining an opening (42) aligned in said direction (A) so as to allow the sound waves generated by the loudspeaker to pass out through the opening (42), said at least one lighting element (200) being associated with the annular support (46) and directed outwards.

### TECHNICAL FIELD

The present invention relates to a light-bulb, and more particularly a light-bulb able to emit sound waves.

The present invention can be used in the sector of lighting technology and more particularly lighting technology combined with acoustics.

### BACKGROUND ART

In the prior art, light-bulbs which are able to provide illumination and at the same time emit sound waves, typically music, within the environment are known.

For example, the patent document US 2007/0121319 illustrates a light-bulb comprising a base and a transparent shell.

A plurality of LEDs and an incandescent light-bulb for emitting light through the shell, in order to illuminate the environment, are known.

Moreover, the light-bulb illustrated in this document has a plurality of electronic accessories for acquiring signals and emitting volatile substances, for example perfume, and sounds depending on these signals.

In particular, the abovementioned light-bulb comprises a receiver for a signal representing sound waves sent from a transmitter associated with a stereo, Mp3 reader or the like, and a loudspeaker for emitting said sound waves having, facing it, a side wall of the base for transmitting said waves into the environment.

Therefore, the following are known: light-bulbs comprising a connector designed to connect the light-bulb to a lamp holder for electrically powering the said light-bulb; a support body defining an inner space housing the components; a lighting element; a receiver which can be connected wirelessly to a device emitting a sound signal, such as a stereo; and a loudspeaker, arranged in the support body and connected to the receiver so as to receive from the receiver said sound signal and emit corresponding sound waves.

These light-bulbs are subject to intense overheating which adversely affects their working life and operation when used for long periods of time.

In this respect it is mentioned in fact that the loudspeaker and the lighting element produce, during operation, a large amount of heat which, if not suitably dissipated, raises the temperature inside the housing space, causing rapid deterioration of the lighting element and the loudspeaker and adversely affecting operation of the said light-bulb.

### DISCLOSURE OF THE INVENTION

In this connection, the technical task forming the basis of the present invention is to propose a light-bulb able to ensure well-defined orientation of the sound and light.

A further object of the present invention is to propose a light-bulb able to suitably dispose of the heat produced during operation thereof.

The technical task mentioned and the objects specified are substantially achieved by a light-bulb, comprising the technical features described in one or more of the accompanying claims.

In particular, the above-mentioned objects are achieved by means of a light-bulb comprising: a connector designed to connect the light-bulb to a lamp holder or to a socket for electrically powering the said light-bulb; a body having a direction of extension and a side wall defining an inner space, said body having a first end connected to the connector and a second open end for defining an outer portion opposite to the engaging connector; a lighting element arranged inside the space; a receiver arranged inside the space and able to be connected wirelessly to a sound signal emitter; an acoustic loudspeaker arranged inside the space and connected to the receiver so as to receive from the receiver said sound signal and emit correspond sound waves.

Such a light-bulb is characterized in that it comprises an annular support arranged inside the space in said outer portion and defining an axial opening aligned in the direction of extension, the lighting element being associated with the outwardly directed annular support and the loudspeaker being oriented towards the opening so that the sound waves produced are able to pass out through the opening itself.

### BRIEF DESCRIPTION OF THE DRAWINGS

Further characteristic features and advantages of the present invention will emerge more clearly from the description, provided by way of a non-limiting example, of a preferred, but not exclusive embodiment of a light-bulb, as illustrated in the accompanying drawings in which:

FIG. 1 shows a perspective view of the light-bulb according to the present invention;

FIG. 2 shows a perspective view of the light-bulb according to FIG. 1 during assembly;

FIGS. 3 and 4 show respective cross-sectional views of the light-bulb according to FIG. 4;

FIG. 5 shows plan view of the light-bulb according to FIGS. 1 to 4;

FIG. 6 is a schematic representation of an audio/lighting system comprising the light-bulb according to FIGS. 1-5 during use.

### DETAILED DESCRIPTION OF PREFERRED EXAMPLES OF EMBODIMENT

With reference to the accompanying figures, the number 1 denotes in its entirety a light-bulb according to the present invention.

The light-bulb 1 comprises a body 5 with an axial direction of extension A and a side wall 41 defining an inner space 90.

The body 5 has a first end connected to a connector 6 and a second open end for defining an outer portion 43 opposite to the engaging connector 6.

It can be seen that the connector 6, in the embodiment shown in the figures, is a standard E27 screw-type connector.

According to other embodiments the connector 6 is a standard GU10 connector.

It should be noted more generally that the connector 6 may be designed with a plurality of standard or non-standard forms.

The connector 6 defines a ferrule for connection to a special lamp holder (not shown) or more generally to a socket for powering the light-bulb 1.

The body 5 has a distal portion 5a remote from the connector 6 and a proximal portion 5b close to the connector 6.

Moreover, it should be noted that preferably the body 5 is shaped substantially in the manner of a bulb.

It should be noted that the body 5 is internally hollow, i.e. the side wall 41 of the body 5 defines an internal cavity for housing the electrical and/or electronic components for illumination and/or sound diffusion as will be explained more clearly below.

The said internal cavity defines the inner space 90.

It should be noted also that the body 5 extends, from the proximal portion 5b close to the connector 6 with a tapering 5c which produces widening of the cross-section.

In the embodiment shown, downstream of the tapering 5c, the proximal portion 5b continues with a substantially prismatic, preferably cylindrical form.

Preferably, the distal portion 5a of the body 5 is at least partly annular.

This light-bulb 1 comprises light-generating means 2 and sound-generating means 3.

The light-generating means 2 comprise a plurality of lighting elements 200.

Each lighting element 200, according to the preferred embodiment, is formed by an LED 12.

The lighting elements 200 are associated with an annular support arranged in the outer portion 43 and directed outwards.

In an alternative embodiment (not shown), the lighting element 200 may be a single component and itself ring-shaped.

The lighting element 200 could also be of a different type, for example a light-bulb of the incandescent or other type.

The annular support 46 defines an opening 42 arranged axially with respect to a direction of extension A of the body 5.

It should be noted moreover that the annular support 46 defines a first electronic board.

The loudspeaker 16 is arranged inside the inner space 90 of the light-bulb 1 so that the sound waves released by the loudspeaker 16 pass out through the opening 42.

The sound-generating means 3 comprise a loudspeaker 16, an amplifier 56 connected to said loudspeaker 16, and an audio signal receiver 15 arranged inside the space 90 and able to be connected without signal cables to a transmitter 32, or to an emitter 32, of a sound signal.

The expression “without signal cables” is understood as meaning that the receiver 15 can be connected without a dedicated cable to the associated transmitter 32.

It should be noted that the term “loudspeaker 16” is used to indicate an electroacoustic transducer able to emit sound waves, in particular in the audible frequency range.

It should be noted that the sound-generating means 3 and the light-generating means 2 are powered by a power supply stage 48.

The power supply stage 48 preferably comprises a transformer electrically connected to the connector 6 so as to receive electric power via the connector 6 in order to supply the electronic components forming part of the said light-bulb with low-voltage power (preferably with a voltage of between 5 and 30 V, even more preferably equal to 12 V).

According to a preferred embodiment, the light-bulb 1 is also provided with control means which are operationally connected to the lighting elements 200 and to the loudspeaker 16 in order to control operation thereof

It should be noted that the control means are able to operate the lighting elements 200 so as to perform, preferably, switching on and off thereof or a continuous or discrete adjustment of the lighting level.

Moreover the control means are able to operate the loudspeaker 16 so as to perform, preferably, switching on and off thereof or a continuous or discrete adjustment of the sound level.

Preferably the control means are connected to means for receiving a control signal emitted by a remote control 28; this aspect will be described more fully below.

Still according to the preferred embodiment, the light-bulb 1 has a plurality of infrared receivers (54a, 54b) associated with the annular support 46.

These infrared receivers (54a, 54b) are LEDs of the infrared type, which are referred to below also as IR LEDs.

FIG. 2 shows a pair of IR LEDs, i.e. a first LED 54a and a second LED 54b.

These IR LEDs (54a, 54b) are preferably able to receive the signal from the remote control 28.

One or more of these IR LEDs may also form part of the receiver 15, namely may be designed to receive the sound signal from the transmitter 32.

It should be noted that, according to another aspect, a remote control 28 of the directional type, designed to send commands to the IR LEDs (54a and/or 54b), is associated with the light-bulb 1.

According to this aspect, the user points the remote control 28 in the direction of the light-bulb 1 and operates corresponding pushbuttons of the remote control 28 so as to impart to the light-bulb 1 commands (for example for activating/deactivating the sound and/or light and/or varying the lighting/sound level).

Advantageously, the remote control 28 allows the user to send commands also to several light-bulbs 1 arranged inside the same environment, without it being necessary to provide a remote control 28 for each light-bulb 1.

In fact, the remote control 28 is directional and operates the light-bulb 1 towards which it is directed.

As an alternative to the infrared receiving means of the light-bulb 1 and the remote control 28 it is envisaged that the light-bulb 1 comprises radio wave receiving means for a control signal and that the user has a device designed to send the control signal to the receiving means of the light-bulb 1 via radio waves.

As already mentioned above, the light-bulb 1 is equipped with a receiver 15.

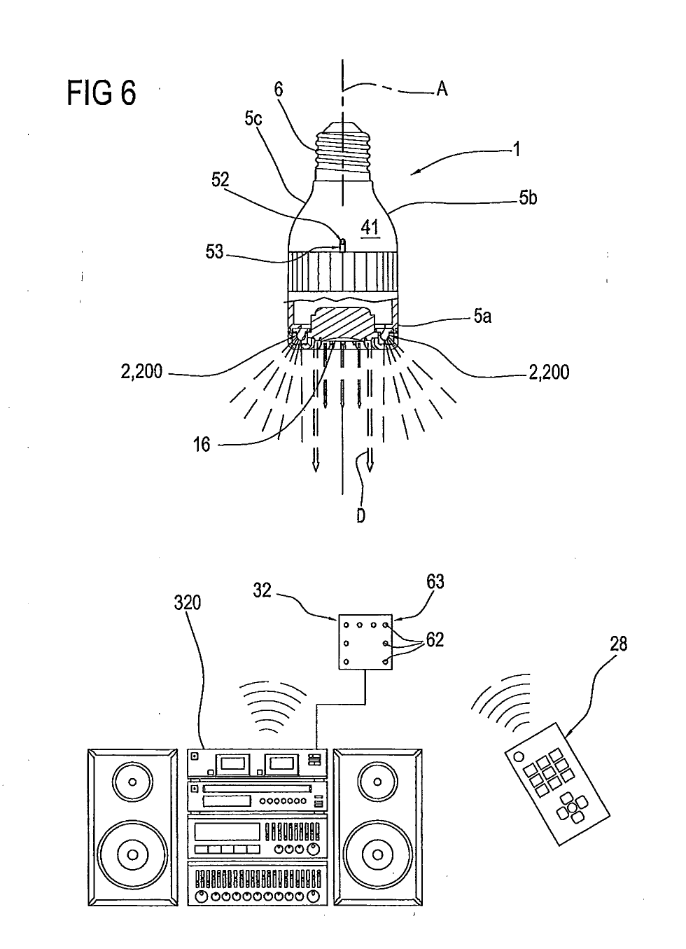

This receiver 15 is able to receive a sound signal (also referred to below as audio signal) from a transmitter 32 which can be connected to a sound source (for example a stereo 320, as shown in FIG. 6).

Preferably, the receiver 15 is a receiver of the IR, i.e. infrared type.

It should be noted that the light-bulb 1 comprises a plurality of LEDs 52.

These LEDs 52 are preferably arranged facing the space 90.

These LEDs 52 are associated with the infrared receiver 15.

It should be noted that, according to the preferred embodiment, the body 5 of the light-bulb 1 has a plurality of openings 53 formed in the side wall 41.

The LEDs 52 are preferably arranged alongside each other opposite the openings 53 (as can be clearly seen in FIG. 6).

Advantageously the arrangement of the LEDs 52 opposite the openings 53 allows reception of the IR signal to be optimized since the LEDs 52 receive the IR signal through the openings 53 and are not affected at all by the screening of the side wall 41.

It should be noted in this respect that the side wall 41 is however preferably transparent to the IR rays; this allows overall the quality of the IR signal received by the LEDs 52 to be increased.

The characteristic features of the transmitter 32 associated with the receiver 15 shall be described further below in detail.

The structure of the light-bulb 1 will be described in detail below with particular reference to the arrangement of the electronic components described above.

It should be noted that this light-bulb 1 is provided with a dissipator element 44.

This dissipator element 44 (preferably annular in shape) forms a part of the side wall 41 of the body 5.

In fact, as can be clearly seen in FIG. 2, the dissipator element 44 is coupled with the body 5 so as to form a portion of the side wall 41 of the body 5.

This dissipator element 44, which is preferably made of metallic material, allows greater dissipation externally of the heat generated inside the inner space 90 of the light-bulb 1 during operation thereof.

Preferably, the dissipator 44 is annular.

Preferably, the dissipator 44 is in contact with the annular support 46.

In particular, it should be noted that the dissipator 44 is provided with a seat 55 for housing the annular support 46.

It should be noted moreover that, according to a preferred embodiment, the dissipator 44 is provided with one or more fins 51; according to variants not shown the dissipator 44 does not have fins 51 and has a smooth outer surface.

The fins 51 may be arranged on the inner surface of the dissipator 44 and/or on the outer surface of the same dissipator 44.

The fins 41 advantageously increase the surface area of the dissipator 44, resulting in a greater overall heat transmission capacity of the dissipator 44.

Preferably, the dissipator 44 is formed so as to bound at least partially the inner space 90.

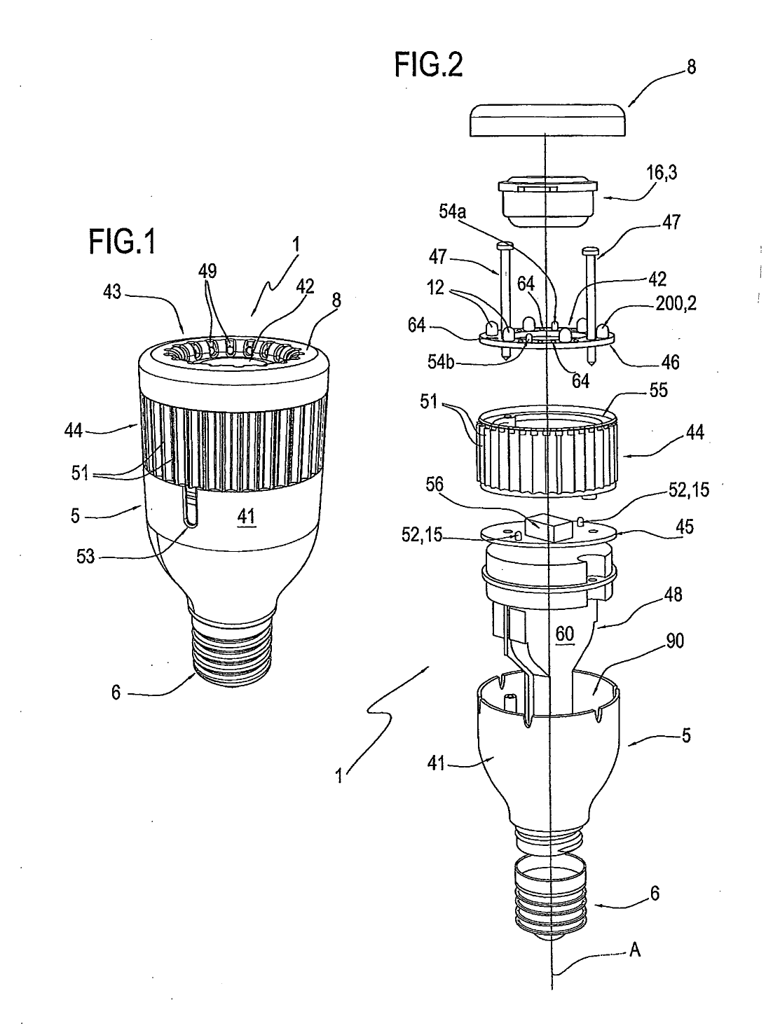

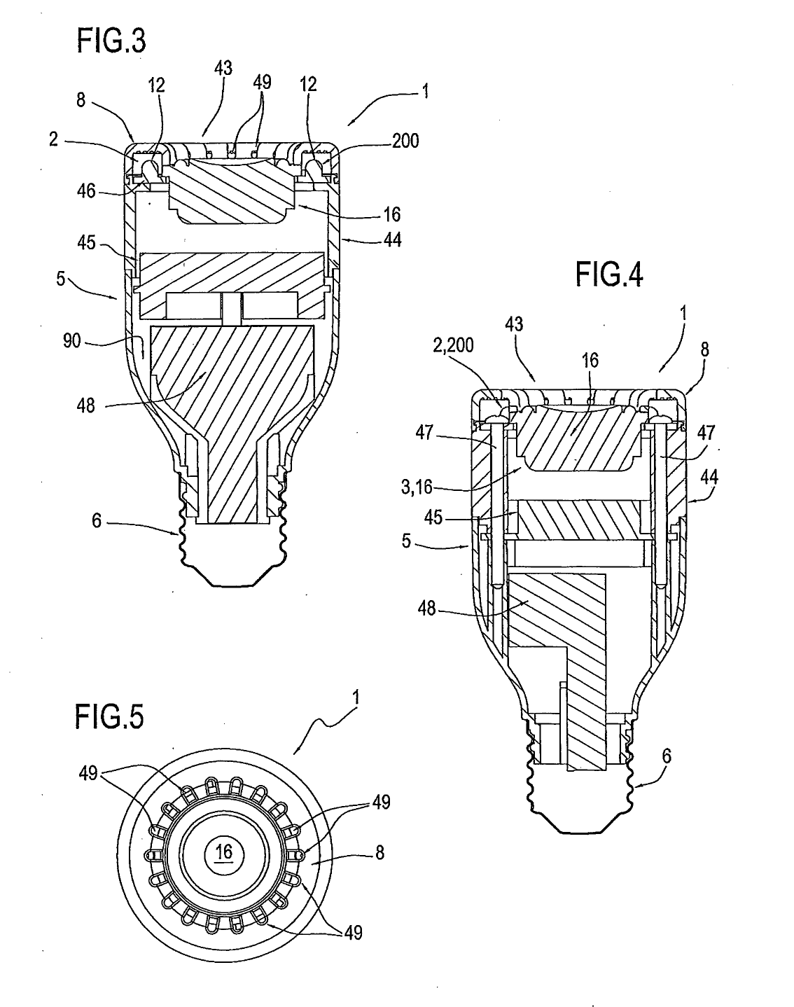

It can be noted from FIG. 1 that the dissipator element 44 is mounted on top of the body 5, defining a portion of the side wall 41.

The characteristic features of the power supply stage 48 will be described below.

The power supply stage 48 is electrically connected to the connector 6 so as to receive electric power via the connector 6 in order to power the electronic components forming part of the same light-bulb 1.

In this connection it should be noted that the power supply stage 48 comprises a voltage transformer (not visible), forming part of the said power supply module and intended to convert the mains voltage into low voltage (preferably in the range of 5 to 30 V, even more preferably equal to 12 V).

According to the preferred embodiment, the power supply stage 48 comprises a sheet-metal screening layer 60 which houses internally the transformer (as an alternative to sheet metal, any material suitable for screening the electromagnetic field may be used) and defines a screen able to reduce the strength of the electromagnetic field generated by the said transformer.

It should be noted that the screening layer prevents the electromagnetic field generated by the transformer during operation of the light-bulb 1 from interfering with the loudspeaker 16 or with other electronic devices forming part of the said light-bulb 1, creating disturbance.

The light-bulb 1 also comprises an intermediate element 45 defining a support for the amplifier 56 and arranged inside the inner space 90, referred to below also as support 45.

It should be noted that this intermediate element 45 defines a second electronic board of the light-bulb 1.

It should also be noted that, according to this aspect, the intermediate element 45 defines a support for the amplifier 56 (schematically shown in FIG. 2) and for the LEDs 52.

The amplifier 56 is electrically connected to the transformer (so as to receive the power supply) and to the receiver 15 (so as to receive the audio signal) and is able to control operation of the loudspeaker 16 with the audio signal received from the receiver 15.

The light-bulb 1 is also provided with a pair of screws 47. These screws 47 constitute means for performing relative fixing of the body 5, the dissipator 44, the annular support 46, the power supply stage 48 and the intermediate element 45.

The fixing screws 47 also have a dual function: they allow relative fixing of the components of the light-bulb 1 (body 5, dissipator 44, annular element 46, power supply stage 48 and intermediate element 45) and also prevent undesirable mechanical vibrations affecting the components of the light-bulb itself during operation of the light-bulb 1.

The light-bulb 1 is also provided with a lens 8.

This lens 8 is arranged on the outer portion 43.

Preferably, this lens 8 has an annular form so as to be positioned opposite the lighting elements 200.

It should be noted that the lens 8 is also provided with an opening through which the sound waves generated by the loudspeaker 16 can pass out.

This annular lens 8 rests preferably on the annular support 46 and on the dissipator 44.

The lens 8 is designed so that the light emitted by the LEDs 200 is transmitted through it.

Preferably the lens 8 has a knurled surface which is configured so as to diffuse the light passing through the lens in such a way as to avoid dazzling a person who is looking at the light-bulb 1 itself.

As known in fact, the LEDs 12 have a fairly small light cone and there is therefore the risk of dazzling a user who views directly the light emitted by the LEDs 12 without any type of screen; this risk is prevented by the lens 8 which is advantageously designed to diffuse the light emitted by the LEDs 12.

Preferably, the annular lens 8 is made of PMMA (polymethylmethacrylate) so as to allow direct transmission of the light rays.

In other embodiments, the annular lens 8 is made of translucent or transparent material so as to allow the light waves to pass through.

It should be noted that the lens 8 has a plurality of holes 49.

These holes 49 are arranged circumferentially on the lens 8.

Moreover, preferably the annular support 46 is provided with a plurality of holes 64.

It should be noted that, according to the invention, the holes 64 in the support allow the inner space 90 to be connected to an external environment.

This allows advantageously air to circulate inside the inner space 90 and to dispose of heat by means of natural convection.

It is pointed out that the holes 64 in the annular support 46 are preferably aligned with the holes 49 in the lens 8 (however, according to variants not shown, the holes in the annular support 46 may also be not aligned).

Advantageously the holes 49 in the lens 8 allow circulation of air from the inner space 90 towards the outside.

In this connection it should be noted the holes 49 co-operate with the openings 53 in the body 5 and with the holes 64 (if present) in the annular support 46 so as to define a path for circulation of fresh air through the inner space 90; the air circulating along this path advantageously passes over the electronic components of the light-bulb 1 (amplifier 56, loudspeaker 16, lighting element 200) arranged in the inner space 90 and performs cooling of the said components by means of natural convection.

In fact, in view of the overheating affecting the light-bulb during operation, the difference in temperature between the air inside the light-bulb 1, which is hotter, and the air outside, which is colder, generates a flow of air out of the inner space 90 through the holes 49 and/or the openings 53.

This aspect is very useful during heat disposal, i.e. dissipation of the heat generated by the light-bulb 1, preventing overheating of the light-bulb 1.

In particular, it should be noted that the inner space 90 defines an air chamber which allows circulation of air from the external environment, which enters via the openings 53 and/or the holes 49.

It should also be noted that, as shown in FIG. 6, the dissipator element 44 is advantageously in contact with the annular support 46 and with the intermediate element 45 so as to define a path with a high heat transmission capacity, allowing the heat to be dissipated from inside the space 90 towards the outside.

According to a preferred embodiment, the dissipator 44 is formed so that its radial thickness diminishes towards the connector 6; this ensures that there is greater heat transmission in the region of the inner space 90 where the amplifier 56 is present, said amplifier, as is known, dissipating large quantities of heat.

In fact, during operation, the amplifier 56 is one of the electronic components of the light-bulb 1 which dissipates a large amount of thermal energy; this thermal energy must be suitably disposed of externally in order to prevent undesirable overheating of the light-bulb itself which adversely affects its performance and reduces its working life.

It should also be noted that the dissipator 44, formed as described above, allows the light-bulb 1 to dissipate the heat in an extremely efficient manner, therefore ensuring a long working life and operating time of the said light-bulb 1.

The transmitter 32, with particular reference to the interaction with the light-bulb 1, is described below.

It should be noted that the transmitter 32 comprises a box-shaped body 63 and means for transmitting an audio signal to the light-bulb 1, arranged inside the box-shaped body 63.

According to a preferred embodiment, the means for transmission of an audio signal comprise a plurality of IR LEDs 62 and the light-bulbs 1 are equipped with the IR LEDs (52, 54a, 54b), as already described above.

The IR LEDs 62 of the transmitter 32 are arranged preferably on a top surface of the box-shaped body 63.

It should be noted that the IR LEDs 62 constitute infrared emitter elements.

It should be noted that preferably the IR LEDs 62 are directed towards the outside of the box-shaped body 63, preferably with an axis inclined with respect to a vertical axis.

Moreover, preferably, the LEDs are arranged on a perimetral portion of the box-shaped body 63 so as to define a U (i.e. on three sides of the box-shaped body 63).

It should be noted that the transmitter 32 thus configured advantageously allows transmission of the signal also in the presence of obstacles (persons, objects) present between the light-bulb 1 and the transmitter 32 itself.

In fact the transmitter 32 generates, by means of a plurality of LEDs 62, a signal which is reflected by the walls of the environment in which it is arranged and which is able to reach the light-bulb 1 even when the infrared LEDs (52, 54a, 54b) of the said light-bulb 1 are not oriented directly towards the transmitter 32 or when an obstacle which is opaque to IR radiation is present between the light-bulb 1 and the transmitter 32.

It should be noted that, according to embodiments not shown, the body 5 of the light-bulb 1 has a form different from a cylindrical form (for example with a square cross-section).

In this connection the components (dissipators 44, annular support 46, intermediate element 45, power supply stage 48) of the light-bulb are formed so that they can be coupled with the body 5 and assembled in the manner already described above.

Another advantageous technical feature of the holes 49 in the lens 8 will be described below.

In order to allow precise orientation of the sound waves emitted from the loudspeaker 16, the holes 49 in the lens 8 are formed so as to generate high-frequency pressure waves which are transmitted through the said holes 49 so as to define a space for propagation of the sound waves emitted.

Preferably, the holes 49 have a flared form, i.e. have a cross-section increasing in the direction A away from the body 5 itself.

“High-frequency pressure waves” are understood as meaning the pressure waves of greater frequency emitted by the loudspeaker 16.

Preferably, these frequencies are at the limit of the audible range, slightly below 20,000 Hz, so as to act as a barrier preventing the passage of sound waves which are nothing other than lower-frequency pressure waves.

In other words, the holes 49 act as a high-pass filter, preventing the passage of the pressure waves with a frequency lower than a predetermined cut-off value.

More precisely, with a reduction in the size of the hole 49, only waves of increasingly higher frequency are able to pass inside them, increasing the cut-off value of the high-pass filter to increasingly higher values.

In other words, the loudspeaker 16 generates pressure waves with frequencies which cover a wide range.

Owing to the presence of the annularly arranged holes 49 it is possible to filter the waves so that only pressure waves with a higher frequency are emitted from the holes, away from the loudspeaker 16.

Since the holes 49 are arranged around the loudspeaker 16, along its peripheral zone, the high-frequency pressure waves generate a prism, preferably a cylinder or zone, forming a “barrier” inside which the lower-frequency pressure waves (sound waves) are forced to remain.

Advantageously, this allows the sounds emitted by the light-bulb 1 to be directed towards a precise point.

Since the propagation space “D” is substantially a cylinder or cone which extends away from the loudspeaker 16 in the main direction of extension “A”, the light and the sound are directed into the same zone.

In fact, the light-bulb 1 emits a ring of light inside which a prism of sound waves is generated.

Advantageously, a user may thus optimize the lighting and sound effects.

According to another variant, the light-bulb 1 is equipped with a receiver 15 designed to receive the audio signal by means of so-called “power line communication” (PLC) technology.

According to this variant, it is envisaged that the transmitter 32 is directly connected to the power mains so as to modulate the audio signal on the power supply itself.

In other words, the transmitter 32 is a PLC transmitter.

The PLC receiver 15 is provided with a filter for separating the audio signal from the electric power entering via the connector 6.

With this variant it is possible to avoid installation of a transmitter 32 in every environment where a light-bulb 1 is present, with obvious advantages in terms of simplicity of management and costs.

In fact the PLC transmitter 32 is able to control operation of a plurality of light-bulbs 1, even when they are arranged in environments which are physically separate and/or very far from each other.

In short, the following should be noted with regard to the arrangement of the electronic components in the light-bulb 1.

The light-bulb 1 is preferably equipped with three electronic boards.
a first electronic board, associated with the annular support 46;
a second electronic board, associated with the intermediate element 45;
a third electronic board, associated with the power supply stage 48.

Advantageously the arrangement of the electronic components on three boards results in optimization of the overall dimensions and at the same time optimization of the heat disposal and efficiency of the lighting and audio devices of the light-bulb 1.

The present invention defines an audio/lighting system, comprising:
one or more light-bulbs 1;
a transmitter 32 designed to transmit a sound signal to the receiver 15 of the light-bulb 1.

Preferably the audio/lighting system also comprises the remote control 28 which advantageously may be designed to emit a command signal to all the light-bulbs.

1. A light-bulb (1) comprising:
a connector (6) designed to connect the light-bulb (1) to a lamp holder or to a socket for electrically powering the said light-bulb (1);
a body (5) having an elongated shape along an axis (A) and a side wall (41) defining an internal space (90), said body (5) having a first end connected to the connector (6) and a second open end for defining an outer portion (43) opposite to the engaging connector (6);
at least one lighting element (200) arranged inside the space (90);
a receiver (15) arranged inside the space (90) and able to communicate wirelessly with a sound signal emitter (32);
an amplifier (56) arranged inside the space (90) and connected to the receiver (15) and to the loudspeaker (16) in order to amplify the signal received from the receiver;
an acoustic loudspeaker (16) arranged inside the space (90) and connected to the amplifier (56) in order to receive said signal and emit corresponding sound waves, characterized in that it comprises an annular support (46) arranged inside the space (90) in said outer portion (43) and defining an opening (42) aligned in said direction (A) so as to allow the sound waves generated by the loudspeaker (16) to be diffused outside the light-bulb through the opening (42), said at least one lighting element (200) being associated with the annular support (46) and directed outwards.

2. The light-bulb according to claim 1, wherein
the acoustic loudspeaker (16) is arranged inside said opening (42) and directed towards the outer portion (43) and wherein the annular support (46) defines a plurality of holes (64) for connecting the inner space (90) to an external environment.

3. The light-bulb according to claim 1, wherein the light-bulb (1) comprises a ring-shaped lens (8) mounted on the annular support (46) so as to protect said at least one lighting element (200).

4. The light-bulb according to claim 3, wherein the acoustic loudspeaker (16) is arranged in said opening (42) and directed towards the outer portion (43) and wherein the annular support (46) and said lens (8) define corresponding pluralities of holes (64; 49) for connecting the inner space (9) to an external environment.

5. The light-bulb according to claim 4, comprising:
means for receiving a command signal transmitted by a remote control (28);
control means connected to the receiving means for receiving the command signal and operationally connected to the lighting element (200) and/or to the loudspeaker (16) so as to control operation thereof.

6. The light-bulb according to claim 1, wherein the side wall (41) is provided with a plurality of openings (53) for connecting the inner space (90) to an external environment.

7. The light-bulb according to claim 1, comprising an annular dissipator (44) defining a portion of the side wall (41).

8. The light-bulb according to claim 7, wherein the thickness of the wall of said dissipator (44) decreases in the direction away from the outer portion (43).

9. The light-bulb according to claim 1, comprising a power supply stage (48) having a transformer connected electrically to the connector (6) and a screening layer for said transformer.

10. The light-bulb according to claim 1, wherein the receiver (15) comprises a plurality of infrared sensors (54a, 54b) arranged on the annular support (46) and directed outwards and a plurality of infrared sensors (52) arranged inside the space (90) facing corresponding openings (53) defined by the side wall of the body.

11. The light-bulb according to claim 1, wherein at least one portion of the side wall (41) is transparent to the infrared radiation so as to allow reception of said infrared radiation.

12. The light-bulb (1) according to claim 1, comprising:
a first electronic board associated with said annular support (46);
a second electronic board (45), arranged inside said inner space (90);
a third electronic board, arranged inside said inner space (90) in the vicinity of the connector (6) and associated with said power supply stage (48), said second electronic board (45) being arranged between the first and third boards.

13. An audio/lighting system, comprising:
at least one light-bulb (1) according to claim 1;
a transmitter (32) designed to transmit a sound signal to the receiver (15) of the light-bulb (1), without the use of dedicated signal cables for the transmission of said signal.

14. The system according to claim 13, wherein said transmitter (32) comprises:
a box-shaped body (63);
a plurality of infrared emitter elements (62) arranged on at least three sides of the box-shaped body (63) so as to transmit infrared signal waves within the environment where the transmitter is located.

15. The system according to claim 13, comprising:
a remote control (28) designed to transmit a command signal and wherein the light-bulb (1) comprises:
means for receiving the command signal transmitted by the remote control (28);
control means connected to the receiving means for receiving the command signal and operationally connected to the lighting element (200) and/or to the loudspeaker (16) so as to control operation thereof.
